(19) United States
(12) Patent Application Publication
(10) Pub. No.: US 2022/0363070 A1
(43) Pub. Date: Nov. 17, 2022

(54) APPARATUS HAVING ONE-WAY VALVES AND FLOAT VALVES

(71) Applicant: Hewlett-Packard Development Company, L.P., Spring, TX (US)

(72) Inventors: Jennifer R. Irvine, Corvallis, OR (US); Mark H. Berg, Corvallis, OR (US)

(73) Assignee: Hewlett-Packard Development Company, L.P., Spring, TX (US)

(21) Appl. No.: 17/637,543

(22) PCT Filed: Oct. 4, 2019
(86) PCT No.: PCT/US2019/054705

§ 371 Date: Feb. 23, 2022

(51) Int. Cl. B41J 2/175; G03G 15/10

(52) U.S. Cl. CPC B41J 2/17596; G03G 15/10

(57) ABSTRACT

In some examples, an apparatus can include a print material cartridge, a reciprocating pump, a first valve, where the first valve is a one-way valve, and a second valve, where the second valve is a float valve, where the reciprocating pump is to cause print material to be supplied to the print material cartridge via the second valve.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is an example of an apparatus having a first valve and a second valve consistent with the disclosure.

FIG. 2 is an example of an apparatus having a check valve and a float valve consistent with the disclosure.

FIG. 3 is an example of an apparatus having cartridge print material below a threshold fill amount during a first cycle sequence of a reciprocating pump consistent with the disclosure.

FIG. 4 is an example of an apparatus having cartridge print material below a threshold fill amount during a second cycle sequence of a reciprocating pump consistent with the disclosure.

FIG. 5 is an example of an apparatus having cartridge print material exceeding a threshold fill amount during a cycle sequence of a reciprocating pump consistent with the disclosure.

FIG. 6 is an example of an apparatus having a check valve and a float valve consistent with the disclosure.

### DETAILED DESCRIPTION

Imaging devices may include a supply of a print material located in a print material cartridge. As used herein, the term “print material” refers to a substance which, when applied to a medium, can form representation(s) (e.g., text, images models, etc.) on the medium during a print job.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like.

The print material cartridge including the print material may be inside of the imaging device and include a supply of the print material such that the print material may be drawn from the print material cartridge as the imaging device creates the images on the print medium. As used herein, the term “print material cartridge” refers to a container, a tank, and/or a similar vessel to store a supply of the print material for use by the imaging device.

As the print material is drawn from the print material cartridge, the amount of print material in the print material cartridge may deplete. As a result, the amount of print material in the print material cartridge of the imaging device may have to be replenished.

Keeping a print material cartridge filled with print material can ensure a print job may be successfully completed. However, in some examples, imaging devices may be moved. For instance, the imaging device may be shipped with the print material cartridge filled with print material, a user may move the imaging device from one location to another, etc. In such examples, the imaging device may be tipped and/or handled during transportation in such a way that print material may leak from the print material cartridge. Additionally, print material may leak from the print material cartridge if the imaging device experiences a temperature change and/or pressure change. Further, displacement of print material in the print material cartridge by gas (e.g., such as air) can cause lead to print material cartridge failure if gas fully displaces the print material in the print material cartridge.

An apparatus having one-way valves and float valves, according to the disclosure, can allow for print material to be supplied to a print material cartridge by way of a one-way valve and a float valve. For example, a reciprocating pump can allow print material to be supplied to the print material cartridge in such a way as to purge gas from the apparatus and the print material cartridge during a fill operation and/or continually purge gas from the print material cartridge during a print job. Print material accordingly can be supplied to the print material cartridge during initial setup and/or during the operational life of the imaging device and/or print material cartridge in a fill operation while continuously purging gas from the apparatus, which can extend the operational life of the print material cartridge as well as the imaging device. Additionally, the apparatus can be connected to a print carriage such that movement of the print carriage can cause print material to be supplied without the use of a dedicated motor, which can simplify the imaging device by including less parts while ensuring the print material level in the print material cartridge is controlled without the use of sensors and/or other equipment. Further, the imaging device can be shipped to a user without print material in the print material cartridge, be transported from one location to another (e.g., such as in an office and/or home setting), as well as experience a temperature and/or pressure change without leaking print material from the print material cartridge.

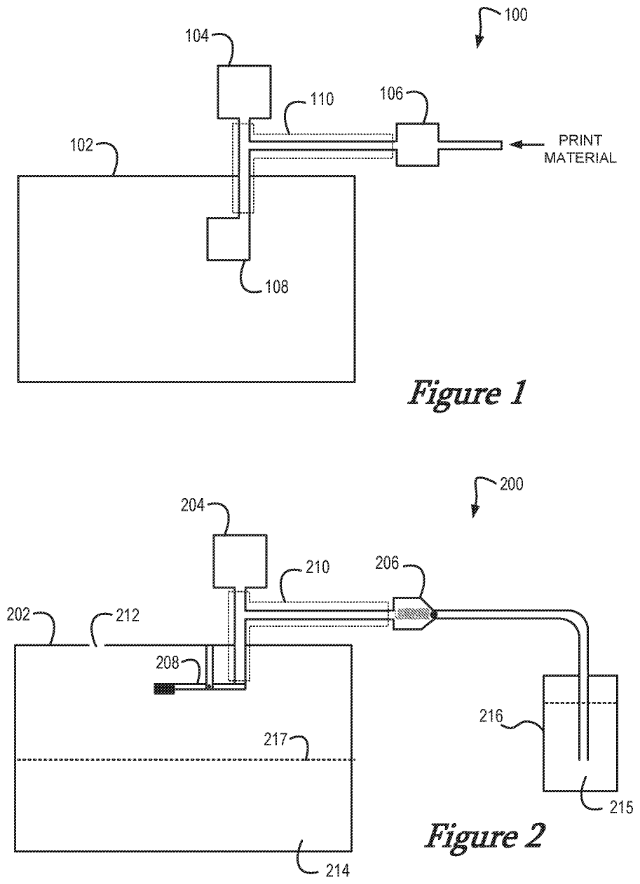

FIG. 1 is an example of an apparatus 100 having a first valve 106 and a second valve 108 consistent with the disclosure. Apparatus 100 can include a print material cartridge 102, a reciprocating pump 104, a first valve 106, a second valve 108, and a staging area 110.

As illustrated in FIG. 1, the apparatus 100 can include a print material cartridge 102. The print material cartridge 102 can be utilized to deposit print material on a physical medium during a print job. In some examples, the print material cartridge 102 can be connected to a print carriage such that during a print job, print material included in the print material cartridge 102 can be deposited on areas of a physical medium in order to physically produce a representation (e.g., text, images, models, etc.) on the physical medium.

As described above, the print material cartridge 102 may have to be filled and/or re-filled with print material. For example, during initial setup of an imaging device and/or the print material cartridge 102, the print material cartridge 102 may be empty and has to be initially supplied with print material. In another example, deposition of print material on a physical medium during a print job can deplete print material in the print material cartridge 102 and print material can be re-supplied to the print material cartridge 102. Supplying print material to the print material cartridge 102 can be accomplished utilizing the reciprocating pump 104, first valve 106, and second valve 108, as is further described herein.

The apparatus 100 can include a reciprocating pump 104. As used herein, the term “reciprocating pump” refers to a positive displacement pump where a volume of fluid is collected in an enclosed volume via suction and discharged from the enclosed volume via pressure. For example, print material can be collected from a supply reservoir (not illustrated in FIG. 1) through the first valve 106 via suction to be collected in the staging area 110, and be discharged from the enclosed volume through the second valve 108 into the print material cartridge 102, as is further described herein.

The apparatus 100 can include a staging area 110. As used herein, the term “staging area” refers to an area where material is assembled before an action is taken. For example, print material can be collected from a supply reservoir through the first valve 106 via suction to be collected in the staging area 110 during a first cycle sequence of the reciprocating pump 104, and be discharged from the staging area 110 through the second valve 108 into the print material cartridge 102 during the second cycle sequence of the reciprocating pump 104.

In some examples, the reciprocating pump 104 can be a bellows pump. As used herein, the term “bellows pump” refers to a positive displacement pump that uses a bellows device to pump fluid through a piping system. However, examples of the disclosure are not limited to a bellows pump. For instance, the reciprocating pump 104 can be any other type positive-displacement pump, such as a piston pump, plunger pump, and/or diaphragm pump, among other examples.

Although not illustrated in FIG. 1, the imaging device can include a print carriage. Movement of the print carriage can cause actuation of the reciprocating pump 104. For example, the print carriage can move causing the reciprocating pump 104 to perform a first cycle sequence and/or a second cycle sequence to occur. The print carriage can cause the cycle sequences to occur during imaging device startup, during a print job, etc. Accordingly, the movement of the print carriage can allow for print material to be supplied to the print material cartridge 102.

The apparatus 100 can include a first valve 106. As used herein, the term “valve” refers to a device to control the flow of a liquid, gas, or other material through a channel. For example, the first valve 106 can control the flow of print material through the apparatus 100, as is further described herein. The first valve 106 can be a one-way valve. For instance, the first valve 106 can be a check valve. As used herein, the term “check-valve” refers to a valve that normally allows fluid to flow through it in one direction. For example, the first valve 106 can allow print material to travel through the first valve 106 in one direction (e.g., right to left as oriented in FIG. 1), but prevent print material from traveling through the first valve 106 in a different direction (e.g., left to right as oriented in FIG. 1).

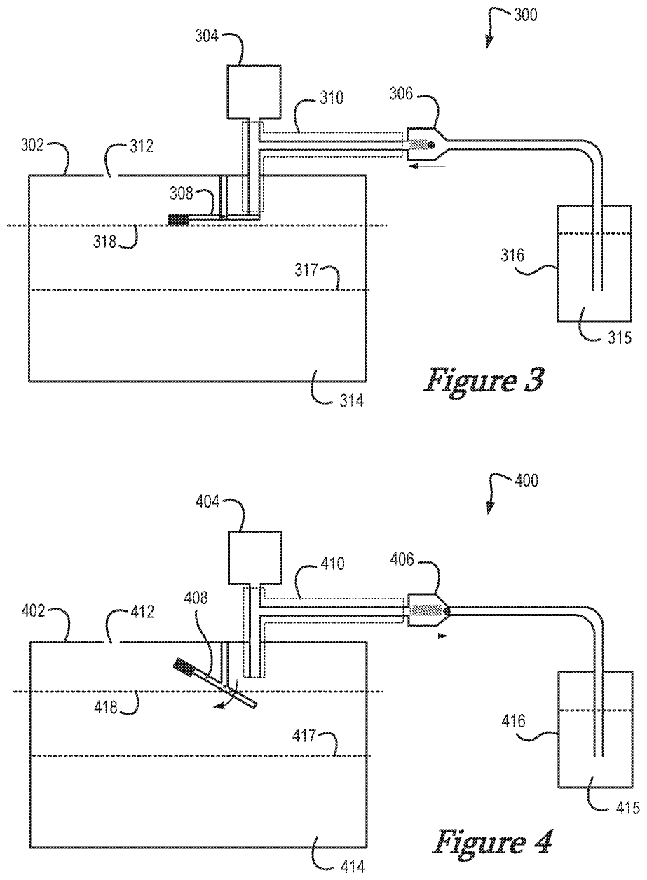

The first valve 106 can include a cracking pressure that is greater than a particular pressure. As used herein, the term “cracking pressure” refers to a minimum differential pressure between an inlet of the first valve 106 and the outlet of the first valve 106. For example, the cracking pressure can be such that the minimum differential pressure between an inlet of the first valve 106 (e.g., the right side of first valve 106, as oriented in FIG. 1) and the outlet of the first valve 106 (e.g., the left side of first valve 106, as oriented in FIG. 1) can be greater than a particular pressure. The cracking pressure of the first valve 106 being greater than the particular pressure can prevent the first valve 106 from allowing print material to pass through the first valve 106 unless acted upon by the reciprocating pump 104 (e.g., during a cycle sequence of the reciprocating pump 104, as is further described in connection with FIGS. 3-5). Accordingly, in an example in which pressure is put on the first valve 106 based on an orientation of the imaging device (e.g., the imaging device is tilted during movement/transportation), change in external pressure, or the like, the first valve 106 can remain closed.

In some examples, the particular pressure can be atmospheric pressure. The particular pressure may be atmospheric pressure in an example in which pressure in the print material cartridge 102 is atmospheric pressure. For example, the cracking pressure of the first valve 106 being greater than atmospheric pressure can prevent the first valve 106 from opening unless a pressure greater than atmospheric pressure acts on the first valve 106.

Although the cracking pressure of the first valve 106 is described above as being atmospheric pressure, examples of the disclosure are not so limited. For example, the cracking pressure of the first valve 106 can be higher than atmospheric pressure, and/or may depend on the pressure in the print material cartridge 102.

The apparatus 100 can include a second valve 108. The second valve 108 can control the flow of print material through the apparatus 100, as is further described herein. The second valve 108 can be a float valve. As used herein, the term “float valve” refers to a valve that is opened or closed based on a float. For example, the second valve 108 can be open when the float of the second valve 108 is floated by a fluid, and can be closed when the float of the second valve 108 is not floated by a liquid.

In some examples, the second valve 108 can be a counter-weight float valve. As used herein, the term “counter-weight float valve” refers to a float valve having a float at the end of a lever. For example, when the float is floated by a fluid, the lever can cause the second valve 108 to be opened, and when the float is not floated by a fluid, the weight of the float at the end of the lever can cause the second valve 108 to be closed, as is further described in connection with FIGS. 2-5.

In some examples, the second valve 108 can be a ball-in-tube float valve. As used herein, the term “ball-and-tube float valve” refers to a float valve having a float located at the end of a tube. For example, when the float is floated by a liquid, the float can cause the second valve 108 to be opened, and when the float is not floated by a fluid, the weight of the float can cause the float to rest in a resting location at the end of the tube to cause the second valve 108 to be closed, as is further described in connection with FIG. 6.

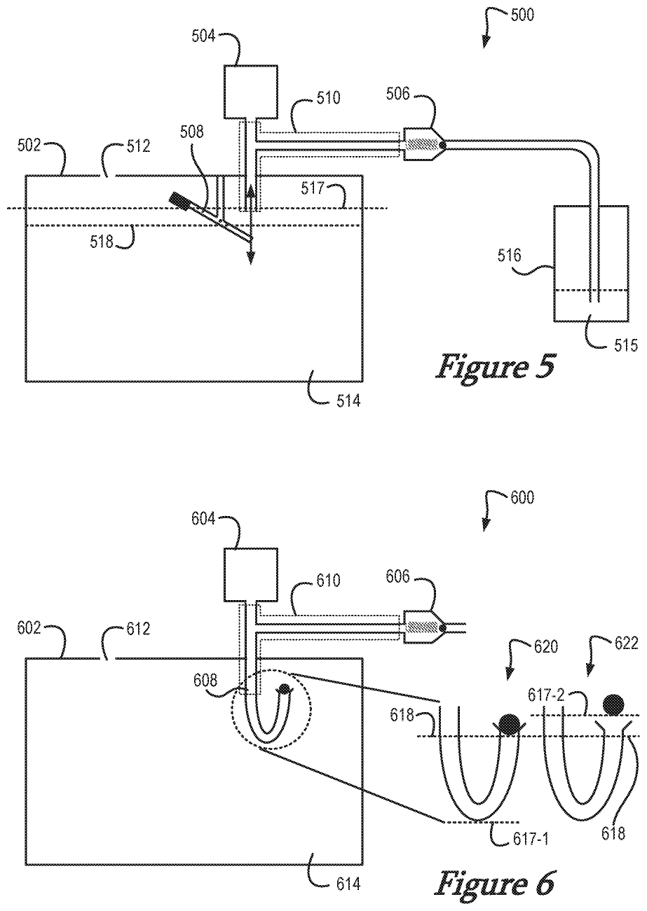

The second valve 108 can operate as a one-way valve or a two-way valve based on a fill amount of print material in the print material cartridge 102. As used herein, the term “two-way valve” refers to a valve that can allow fluid through in a first direction or a second direction. The second valve 108 can operate as a one-way valve when the print material cartridge 102 includes a print material fill amount that is below a threshold fill amount, as is further described in connection with FIGS. 3 and 4. Further, the second valve 108 can operate as a two-way valve when the print material cartridge 102 includes a print material fill amount that exceeds a threshold amount, as is further described in connection with FIG. 5.

The reciprocating pump 104 can cause print material to be supplied to the print material cartridge 102 via the second valve 108. The displaced air can exit through a vent (e.g., vent 212, 312, 412, 512, 612, as is further described in connection with FIGS. 2-6, respectively). For example, the reciprocating pump 104 can cause print material to transit from a supply reservoir (e.g., not illustrated in FIG. 1), through the first valve 106 to a staging area located between the first valve 106 and the second valve 108, and to the print material cartridge 102 through the second valve 108, as is further described herein.

FIG. 2 is an example of an apparatus 200 having a check valve 206 and a float valve 208 consistent with the disclosure. Apparatus 200 can include a print material cartridge 202, a reciprocating pump 204, a check valve 206 (e.g., first valve 106, previously described in connection with FIG. 1), and a float valve 208 (e.g., second valve 108, previously described in connection with FIG. 1).

As illustrated in FIG. 2 and previously described in connection with FIG. 1, the apparatus 200 can include a print material cartridge 202. The print material cartridge 202 can include cartridge print material 214. For example, the print material cartridge 202 can be utilized to deposit cartridge print material 214 on a physical medium during a print job. The print material cartridge 202 may have to be filled and/or re-filled with supply print material 215, as is further described herein.

The apparatus 200 can include the reciprocating pump 204, the check valve 206, and the float valve 208. Utilizing the reciprocating pump 204, the check valve 206, and the float valve 208, the apparatus 200 can supply the print material cartridge 202 with supply print material 215, as is further described herein.

The check valve 206 can be a one-way valve. For example, the check valve 206 can allow print material to travel through the check valve 206 in one direction (e.g., right to left as oriented in FIG. 2), but prevent print material from traveling through the check valve 206 in a different direction (left to right as oriented in FIG. 2).

The float valve 208 can be a counter-weight float valve and can operate as a one-way valve or a two-way valve based on a fill amount 217 of print material in the print material cartridge 202 relative to a threshold fill amount. As used herein, the term “threshold fill amount” refers to a volume of print material in the print material cartridge 202 that, when exceeded, causes a float of the float valve 208 to float. For example, the float valve can operate as a two-way valve in response to the print material cartridge 202 being at a second print material fill amount that exceeds the threshold fill amount that causes the float of the float valve 208 to float. The float valve can operate as a one-way valve in response to the print material cartridge 202 being at a first print material fill amount that is below the threshold fill amount (e.g., as illustrated in FIG. 2).

The apparatus 200 can include a staging area 210. For example, print material can be collected from a supply reservoir 216 through the check valve 206 via suction to be collected in the staging area 210 during a first cycle sequence of the reciprocating pump 204, and be discharged from the staging area 210 through the float valve 208 into the print material cartridge 202 during the second cycle sequence of the reciprocating pump 204, as is further described herein. The print material can be discharged into the print material cartridge 202 displacing air which can exit via vent 212.

As described above, the reciprocating pump 204 can cause supply print material 215 to be transited during a cycle sequence of the reciprocating pump 204. As used herein, the term “cycle sequence” refers to an action taken by the pump to collect or discharge fluid. For example, a first cycle sequence can collect a volume of fluid (e.g., print material) in an enclosed volume via suction, and a second cycle sequence can discharge the volume of fluid (e.g., the print material) from the enclosed volume via pressure. The reciprocating pump 204 can cause the supply print material 215 to be transited via pressure and/or vacuum.

As described above, the cycle sequence of the reciprocating pump 204 can include a first cycle sequence and a second cycle sequence. For example, during the first cycle sequence, the reciprocating pump 204 can collect a volume of print material in the staging area 210 via suction during the first cycle sequence and discharge the volume of print material from the staging area 210 via pressure during the second cycle sequence. As is further described in connection with FIGS. 3-5, the source of the print material collected in the staging area 210 can depend on the print material fill amount 217 in the print material cartridge 202. That is, the print material collected in the staging area 210 can be transited from the supply reservoir 216 if the print material fill amount 217 in the print material cartridge 202 is less than a threshold fill amount, or the print material collected in the staging area 210 can be transited from the print material cartridge 202 if the print material fill amount 217 in the print material cartridge 202 exceeds the threshold fill amount.

In an example in which the print material fill amount 217 in the print material cartridge 202 is below the threshold fill amount, during the first cycle sequence of the reciprocating pump 204, the supply print material 215 can be transited from the supply reservoir 216 to the staging area 210, as is further described in connection with FIG. 3. During the second cycle sequence of the reciprocating pump 204, the print material can be transited from the staging area 210 to the print material cartridge 202, as is further described in connection with FIG. 4.

In an example in which the print material fill amount 217 in the print material cartridge 202 exceeds the threshold fill amount, during the first cycle sequence of the reciprocating pump 204, the cartridge print material 214 can be transited from the print material cartridge 202 to the staging area 210, as is further described in connection with FIG. 5. During the second cycle sequence of the reciprocating pump 204, the print material can be transited from the staging area 210 to the print material cartridge 202, as is further described in connection with FIG. 5.

The backpressure for the nozzle of the print material cartridge 202 can be controlled by foam. Foam can control the backpressure in order to prevent cartridge print material 214 located in the print material cartridge 202 from unintentionally leaking through print nozzles of the print material cartridge 202. For example, a foam material can be located between the cartridge print material 214 and the nozzle of the print material cartridge 202. The cartridge print material 214 can travel through pores in the foam material by capillary action to be ejected through the nozzle of the print material cartridge 202, where the backpressure in the print material cartridge 202 can be controlled by the pore size of the foam material. For instance, the smaller the pore size in the foam material, the higher the backpressure for the nozzle of the print material cartridge 202. In some examples, the foam material can be a Polyvinyl Alcohol (PVA), among other examples. Further, although the backpressure is described as being controlled by foam, examples of the disclosure are not so limited. For example, the backpressure of the print material cartridge 202 can be controlled by a sponge material.

FIG. 3 is an example of an apparatus 300 having cartridge print material 314 below a threshold fill amount 318 during a first cycle sequence of a reciprocating pump 304 consistent with the disclosure. Apparatus 300 can include a print material cartridge 302, a reciprocating pump 304, a check valve 306, a float valve 308, and a staging area 310. The float valve 308 can be a counter-weight float valve. The print material cartridge 302 can include a vent 312 and cartridge print material 314. The supply reservoir 316 can include supply print material 315. Utilizing the reciprocating pump 304, the check valve 306, and the float valve 308, the apparatus 300 can supply the print material cartridge 302 with cartridge print material 314, as is further described herein.

As illustrated in FIG. 3, the print material cartridge 302 can include cartridge print material 314. The print material cartridge 302 can include a fill amount 317 of cartridge print material 314 that is less than the threshold fill amount 318. Accordingly, the float valve 308 can operate as a one-way valve to allow print material to transit in a single direction, as is further described herein.

As previously described in connection with FIG. 2, the reciprocating pump 304 can include a first cycle sequence and a second cycle sequence. As illustrated in FIG. 3, the reciprocating pump 304 can be performing the first cycle sequence to cause supply print material 315 to transit to the staging area 310, as is further described herein.

During the first cycle sequence of the reciprocating pump 304, suction created by the first cycle sequence of the reciprocating pump 304 can cause the check valve 306 to open. For example, the pressure acting on the check valve 306 as a result of the suction created by the first cycle sequence of the reciprocating pump 304 can be greater than the cracking pressure of the check valve 306 causing it to open. Further, supply print material 315 can transit from the supply reservoir 316, through the check valve 306, and to the staging area 310 of the apparatus 300. Further, the weight of the float of the float valve 308 can cause the float valve 308 to remain closed during the first cycle sequence of the reciprocating pump 304 which allows the reciprocating pump 304 to create a low pressure (e.g., a vacuum) to draw supply print material 315 from the supply reservoir 316 past the check valve 306. The print material located in the staging area 310 can be supplied to the print material cartridge 302 during the second cycle sequence of the reciprocating pump 304, as is further described in connection with FIG. 4.

FIG. 4 is an example of an apparatus 400 having cartridge print material 414 below a threshold fill amount 418 during a second cycle sequence of a reciprocating pump 404 consistent with the disclosure. Apparatus 400 can include a print material cartridge 402, a reciprocating pump 404, a check valve 406, a float valve 408, and a staging area 410. The float valve 408 can be a counter-weight float valve. The print material cartridge 402 can include a vent 412 and cartridge print material 414. The supply reservoir 416 can include supply print material 415. Utilizing the reciprocating pump 404, the check valve 406, and the float valve 408, the apparatus 400 can supply the print material cartridge 402 with print material, as is further described herein.

As previously described in connection with FIG. 3, the print material cartridge 402 can include a fill amount 417 of cartridge print material 414 that is less than the threshold fill amount 418. Accordingly, the float valve 408 can continue to operate as a one-way valve to allow print material to transit in a single direction, as is further described herein. As illustrated in FIG. 4, the reciprocating pump 404 can be performing the second cycle sequence to cause supply print material 415 to transit from the staging area 410, as is further described herein.

As a result of the first cycle sequence of the reciprocating pump 404 ending, the suction created by the first cycle sequence can dissipate, causing the check valve 406 to close. Prior to the reciprocating pump 404 beginning the second cycle sequence, the weight of the float of the float valve 408 can keep the float valve 408 closed so that the print material located in the staging area 410 remains in the staging area 410 until the second cycle sequence begins.

During the second cycle sequence of the reciprocating pump 404, pressure created by the second cycle sequence of the reciprocating pump 404 can cause the float valve 408 to open. The pressure created during the second cycle sequence of the reciprocating pump 404 can cause the print material located in the staging area 410 to transit into the print material cartridge 402, causing displaced air to exit vent 412. The pressure further prevents the check valve 406 from opening during the second cycle sequence. Following the completion of the second cycle sequence and the expulsion of the print material from the staging area 410 into the print material cartridge 402, the weight of the float of the float valve 408 can cause the float valve 408 to close.

As previously described in connection with FIG. 1, the apparatus 400 can be connected to a print carriage. During the print job, movement of the print carriage can cause actuation of the reciprocating pump 404. For example, movement of the print carriage can cause the first cycle sequence and/or the second cycle sequence to occur, providing print material to be supplied to the print material cartridge 402 without a dedicated motor.

As print material is supplied to the print material cartridge 402, gas located above the fill level of the cartridge print material 414 can be displaced. Accordingly, vent 412 can allow gas to escape the print material cartridge 402 as cartridge print material 414 is supplied to the print material cartridge 402. As used herein, the term “vent” refers to an opening to allow for transmission (e.g., to emit and/or take in) of gas. The vent 412 can allow for purging of gas (e.g., air) in the print material cartridge 402, the staging area 410, and/or in the piping between the check valve 406 and the supply reservoir 416 as the print material cartridge 402 is supplied with cartridge print material 414, which can prolong the life of the print material cartridge 402. Further, the vent 412 can allow for gas to enter the print material cartridge 402 during a first cycle sequence of the reciprocating pump 404 when the print material fill amount 417 in the print material cartridge 402 exceeds the threshold fill amount 418 to prevent a vacuum from being created in the print material cartridge 402, as is further described in connection with FIG. 5.

FIG. 5 is an example of an apparatus 500 having cartridge print material 514 exceeding a threshold fill amount 518 during a cycle sequence of a reciprocating pump 504 consistent with the disclosure. Apparatus 500 can include a print material cartridge 502, a reciprocating pump 504, a check valve 506, a float valve 508, and a staging area 510. The float valve 508 can be a counter-weight float valve. The print material cartridge 502 can include a vent 512 and cartridge print material 514. The supply reservoir 516 can include supply print material 515.

As illustrated in FIG. 5, the print material cartridge 502 can include cartridge print material 514. The print material cartridge 502 can include a fill amount 517 of cartridge print material 514 (e.g., illustrated as a dashed line within the print material cartridge 502) that exceeds the threshold fill amount 518. The cartridge print material 514 located in the print material cartridge 502 can be such that it can interact with the float of the float valve 508 to cause the float to float. As a result, the float valve 508 can be normally open. Accordingly, the float valve 508 can operate as a two-way valve to allow print material to transit in multiple directions, as is further described herein.

During the first cycle sequence of the reciprocating pump 504, suction created by the first cycle sequence can cause some of the cartridge print material 514 from the print material cartridge 502 to be transited through the open float valve 508 and into the staging area 510. Since the first cycle sequence causes the cartridge print material 514 from the print material cartridge 502 to transit into the staging area 510, the suction created by the first cycle sequence is not greater than the cracking pressure of the check valve 506, so the check valve 506 remains closed during the first cycle sequence.

During the second cycle sequence of the reciprocating pump 504, pressure created by the second cycle sequence can cause the print material located in the staging area 510 to transit back into the print material cartridge 502 through the open float valve 508. The pressure further prevents the check valve 506 from opening during the second cycle sequence. Since the print material fill amount 517 is above the threshold fill amount 518, the float valve 508 remains open. The print material located in the staging area 510 can transit back into the print material cartridge 502 to promote recirculation of the print material in the print material cartridge 502. Further, the float valve 508 can be in contact with print material to keep the float valve 508 wet with print material to reduce and/or prevent print material from drying in the float valve 508, reducing chances of the float valve 508 malfunctioning.

FIG. 6 is an example of an apparatus 600 having a check valve 606 and a float valve 608 consistent with the disclosure. Apparatus 600 can include a print material cartridge 602, a reciprocating pump 604, a check valve 606, a float valve 608, and a staging area 610. The print material cartridge 602 can include a vent 612 and print material 614.

As illustrated in FIG. 6, the float valve 608 can be a ball-and-tube float valve. For example, the float valve 608 can operate as a one-way valve in response to the print material cartridge 602 being at a print material fill amount 617-1 (e.g., at 620) that is below the threshold fill amount 618, or can operate as a two-way valve in response to the print material cartridge 602 being at a print material fill amount 617-2 (e.g., at 622) that exceeds the threshold fill amount 618 that causes the float of the float valve 608 to float.

In an example in which the print material fill amount 617-1 in the print material cartridge 602 is below the threshold fill amount 618 (e.g., at 620), during the first cycle sequence of the reciprocating pump 604, the print material 614 can be transited from a supply reservoir to the staging area 610. For example, during the first cycle sequence the reciprocating pump 604 can create suction causing the check valve 606 to open such that print material can transit through the check valve 606 and into the staging area 610, while the same suction in addition to the weight of the float cause the float valve 608 to remain closed. During the second cycle sequence of the reciprocating pump 604, pressure created can cause the print material in the staging area 610 to push the float upwards allowing the print material to be transited from the staging area 610 to the print material cartridge 602.

In an example in which the print material fill amount 617-2 in the print material cartridge 602 exceeds the threshold fill amount 618 (e.g., at 622), the float of the float valve 608 can be afloat as a result of the print material fill amount in the print material cartridge 602. During the first cycle sequence of the reciprocating pump 604, the print material 614 can be transited from the print material cartridge 602 to the staging area 610 through the open float valve 608. During the second cycle sequence of the reciprocating pump 604, the print material 614 can be transited from the staging area 610 to the print material cartridge 602 through the open float valve 608 (e.g., in an example in which the amount of print material transited from the print material cartridge 602 into the staging area 610 is such that the print material fill amount in the print material cartridge 602 still exceeds the threshold fill amount) or through a closed float valve 608 (e.g., in an example in which the amount of print material transited from the print material cartridge 602 into the staging area 610 is such that the print material fill amount in the print material cartridge 602 dips below the threshold fill amount and the float of the float valve 608 is no longer floated by the print material 614, causing the float valve 608 to close).

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a print material cartridge;
a reciprocating pump;
a first valve, wherein the first valve is a one-way valve; and
a second valve, wherein the second valve is a float valve;
wherein the reciprocating pump is to cause print material to be supplied to the print material cartridge via the second valve.

2. The apparatus of claim 1, wherein the second valve is to operate as a one-way valve when the print material cartridge includes a print material fill amount that is below a threshold fill amount.

3. The apparatus of claim 1, wherein the second valve is to operate as a two-way valve when the print material cartridge includes a print material fill amount that exceeds a threshold fill amount.

4. The apparatus of claim 1, wherein the first valve includes a cracking pressure that is greater than atmospheric pressure.

5. The apparatus of claim 1, wherein the reciprocating pump is to cause print material to be supplied to the print material cartridge from a supply reservoir via pressure.

6. A print material supply, comprising:
a print material cartridge;
a reciprocating pump;
a check valve, wherein the check valve is a one-way valve;
a float valve, wherein the float valve:
is to operate as a one-way valve in response to the print material cartridge being at a first print material fill amount that is below a threshold fill amount; and
is to operate as a two-way valve in response to the print material cartridge being at a second print material fill amount that exceeds the threshold fill amount; and
a staging area between the check valve and the float valve;
wherein the reciprocating pump is to cause print material to be transited during a cycle sequence of the reciprocating pump.

7. The print material supply of claim 6, wherein the cycle sequence of the reciprocating pump includes a first cycle sequence and a second cycle sequence.

8. The print material supply of claim 7, wherein:
in response to the print material cartridge being at the first print material fill amount, the check valve is to open to cause print material to be transited from a supply reservoir through the check valve and into the staging area during the first cycle sequence of the reciprocating pump; and
the float valve is to remain closed.

9. The print material supply of claim 8, wherein in response to the print material cartridge being at the first print material fill amount, the check valve is to close and the float valve is to open to cause the print material located in the staging area to be transited from the staging area and into the print material cartridge during the second cycle sequence of the reciprocating pump.

10. The print material supply of claim 7, wherein:
in response to the print material cartridge being at the second print material fill amount, print material in the print material cartridge causes the float valve to be normally open to cause a portion of the print material in the print material cartridge to be transited through the float valve and into the staging area during the first cycle sequence of the reciprocating pump; and
the check valve is to remain closed.

11. The print material supply of claim 10, wherein in response to the print material cartridge being at the second print material fill amount, the print material in the staging area is to be transited through the float valve and into the print material cartridge during the second cycle sequence of the reciprocating pump; and
the check valve is to remain closed.

12. A system, comprising:
a print material cartridge including a vent to allow gas to escape the print material cartridge as print material is supplied to the print material cartridge;
a reciprocating pump;
a one-way check valve;
a float valve, wherein the float valve:
is to operate as a one-way valve in response to the print material cartridge being at a first print material fill amount that is below a threshold fill amount; and
is to operate as a two-way valve in response to the print material cartridge being at a second print material fill amount that exceeds the threshold fill amount; and
a staging area between the check valve and the float valve;
wherein during a cycle sequence of the reciprocating pump, the reciprocating pump is to cause print material to be transited to the staging area.

13. The system of claim 12, wherein during a first cycle sequence of the reciprocating pump:
print material is to be transited from a supply reservoir to the staging area in response to the print material fill amount in the print material cartridge being below the threshold fill amount; and
a portion of print material in the print material cartridge is to be transited from the print material cartridge to the staging area in response to the print material fill amount in the print material cartridge exceeding the threshold fill amount.

14. The system of claim 13, wherein during a second cycle sequence of the reciprocating pump:
the print material from the supply reservoir is to be transited from the staging area to the print material cartridge; and
the print material from the print material cartridge is to be transited from the staging area to the print material cartridge.

15. The system of claim 12, wherein the float valve is at least one of:
a counter-weight float valve; or
a ball-in-tube float valve.
